(19) United States
(12) Patent Application Publication
(10) Pub. No.: US 2017/0359687 A1
(43) Pub. Date: Dec. 14, 2017

(54) ELECTRONIC DEVICE

(71) Applicant: Panasonic Intellectual Property Management Co., Ltd., Osaka (JP)

(72) Inventor: Katsunao TAKAHASHI, Osaka (JP)

(21) Appl. No.: 15/670,585

(22) Filed: Aug. 7, 2017

Related U.S. Application Data
(63) Continuation of application No. PCT/JP2016/000457, filed on Jan. 29, 2016.

(30) Foreign Application Priority Data
Feb. 17, 2015 (JP) 2015-028976

(51) Int. Cl. H04W 4/02; G06F 21/34; H04W 12/12; G06F 21/85; H04L 29/06; G06F 21/73

(52) U.S. Cl. CPC H04W 4/021; G06F 21/85; H04L 63/107; G06F 21/34; H04W 12/12; G06F 21/73; G06Q 2220/10; G06F 2221/2129

(57) ABSTRACT

An electronic device includes a radio communication unit as an obtainment unit that obtains an SSID of position-dependent information, the position-dependent information being information depending on a position of the electronic device, and a storage in which an SSID table is stored, the SSID table managing the SSID obtained by the radio communication unit and authentication information used by a user to log in to the electronic device while correlating the SSID and the authentication information to each other. The electronic device also includes a controller that performs operating environment setting of the electronic device. The controller compares the SSID obtained in predetermined timing by the radio communication unit with an SSID corresponding to the authentication information about the currently logged-in user in SSIDs managed by the SSID table, and changes the operating environment setting of the electronic device according to a comparison result.

### BACKGROUND

### 1. Technical Field

The present disclosure relates to an electronic device with changeable operating environment setting.

### 2. Description of Related Art

Unexamined Japanese Patent Publication No. 2011-215952 discloses a technique in which, in order to improve security in case of theft, an electronic device connectable to a wireless LAN (Local Area Network) performs normal operation during connection to an access point having an SSID (Service Set Identifier) identical to a predetermined SSID, and the electronic device is put into a locked state when disconnected from the access point, thereby preventing unauthorized used of the electronic device.

However, in a case of the electronic device disclosed in Unexamined Japanese Patent Publication No. 2011-215952, when an authorized user moves with the electronic device while the electronic device is connected to the access point having the previously-set SSID, the electronic device may be disconnected from the access point, and the electronic device becomes the locked state. In this case, even the authorized user cannot use the electronic device at all, thereby degrading user-friendliness.

The present disclosure provides an electronic device in which both the security and the user-friendliness can be achieved.

### SUMMARY

According to one aspect of the present disclosure, an electronic device includes: an obtainment unit that obtains position-dependent information, the position-dependent information being information depending on a position of the electronic device; a storage in which a table is stored, the table managing the position-dependent information obtained by the obtainment unit and authentication information used by a user to log in to the electronic device while correlating the position-dependent information and the authentication information to each other; and a controller that performs operating environment setting of the electronic device. The controller compares the position-dependent information obtained in predetermined timing by the obtainment unit with the position-dependent information corresponding to the authentication information about the user who is currently logged in to the electronic device in pieces of position-dependent information managed by the table, and changes the operating environment setting of the electronic device according to a comparison result.

Thus, the operating environment setting of the electronic device is automatically changed at a position different from a use place associated with the position-dependent information correlated with the authentication information about the user. Accordingly, in the case where a person other than the authorized user takes out the electronic device out of the place associated with the position-dependent information, and even if the person can log in to the electronic device, the electronic device operates under the operating environment setting different from that of the authorized user. For example, when the operating environment setting includes enough restrictions on functions of the electronic device, the person other than the authorized user is prevented from accessing the data of the authorized user. Therefore, the security is improved. When the authorized user moves to a movement position with the electronic device, the electronic device can be operated under the operating environment setting corresponding to the movement position, therefore, the electronic device provides a better user-friendliness. Accordingly, in the present disclosure, both the security and the user-friendliness can be achieved.

### BRIEF DESCRIPTION OF DRAWINGS

FIG. 1 is a perspective view illustrating an appearance of an electronic device according to a first exemplary embodiment;

FIG. 2 is a block diagram illustrating a configuration of the electronic device according to the first exemplary embodiment;

FIG. 3 is a view illustrating an example of a radio wave environment in order to describe operation of the electronic device according to the first exemplary embodiment;

FIG. 4 is a flowchart illustrating operating environment setting processing during starting of the electronic device according to the first exemplary embodiment;

FIG. 5 is a view illustrating an example of an SSID table of the electronic device according to the first exemplary embodiment;

FIG. 6 is a view illustrating an example of an operating environment setting table of the electronic device according to the first exemplary embodiment;

FIG. 7 is a view illustrating another example of the SSID table of the electronic device according to the first exemplary embodiment;

FIG. 8 is a flowchart illustrating SSID recording processing during the operation of the electronic device according to the first exemplary embodiment;

FIG. 9 is a view illustrating still another example of the SSID table of the electronic device according to the first exemplary embodiment;

FIG. 10 is a view illustrating yet another example of the SSID table of the electronic device according to the first exemplary embodiment; and

FIG. 11 is a view illustrating an example of an SSID and operating environment setting table of an electronic device according to a second exemplary embodiment.

### DETAILED DESCRIPTION

Exemplary embodiments will be described below in detail with reference to the drawings appropriately. However, detailed descriptions more than necessary may be omitted. For example, there is a case where detailed description of already well-known items and repeated description with respect to substantially the same configuration are omitted. These omissions are made to avoid unnecessary redundancy of the following description, and to facilitate the understanding of those skilled in the art.

Note that the inventor of the present disclosure provides the accompanying drawings and the following description in order to allow those skilled in the art to fully understand the present disclosure, and does not intend to limit the subject matter as described in the appended claims.

### First Exemplary Embodiment

A first exemplary embodiment will be described below with reference to the drawings.

1-1. Configuration

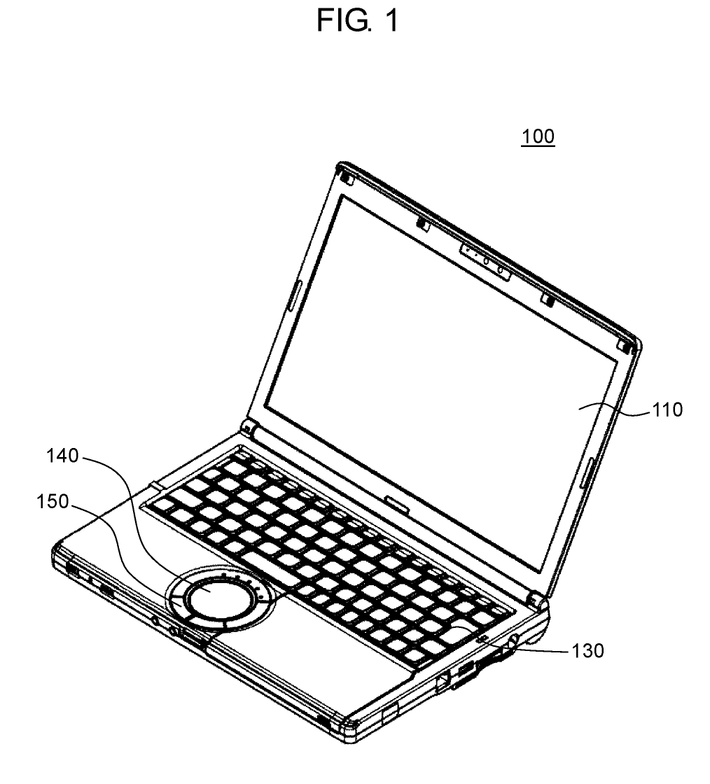

FIG. 1 is a perspective view illustrating an appearance of an electronic device of the first exemplary embodiment.

Electronic device 100 is a notebook computer.

Electronic device 100 includes display 110, keyboard 130, touch pad 140, and operation button 150.

Display 110 displays an image or a video based on an input image signal. For example, display 110 is configured by a liquid crystal display.

Keyboard 130, touch pad 140, and operation button 150 receive user's operation.

Keyboard 130 includes a plurality of keys, and outputs a signal corresponding to a key pressed by a user.

Touch pad 140 is a pointing device that outputs a signal according to a position touched by a user.

Operation button 150 outputs a signal indicating pressing down of operation button 150 when a user presses operation button 150. For example, operation button 150 is used as a decision button.

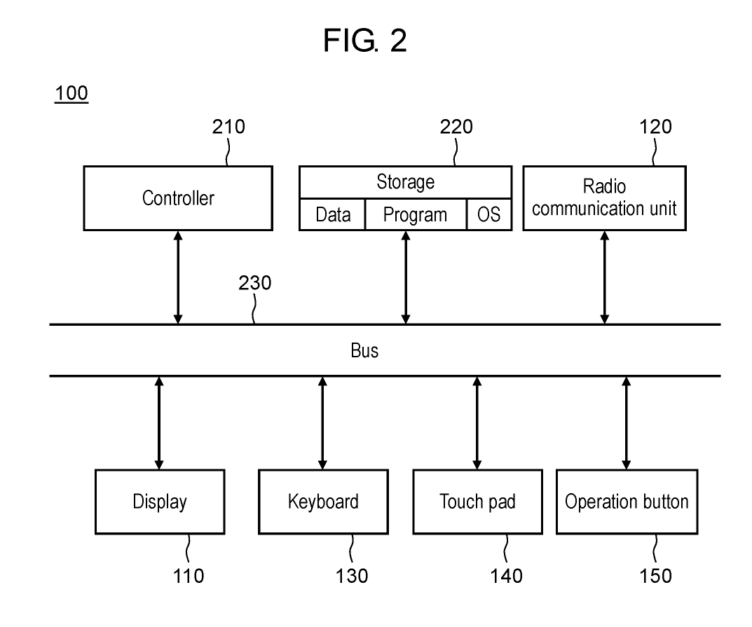

FIG. 2 is a block diagram illustrating a configuration of electronic device 100 according to the first exemplary embodiment.

Electronic device 100 further includes radio communication unit 120, controller 210, storage 220, and bus 230.

Radio communication unit 120 can transmit and receive a wireless-LAN radio signal of an IEEE 802.11 standard (such as 11a, 11b, 11g, and 11n). Radio communication unit 120 demodulates the radio signal received from an access point (master unit), and outputs a demodulated signal. Radio communication unit 120 also demodulates a signal input from controller 210, and outputs a radio signal. Information indicated by the demodulated signal includes the SSID, which is identification information for identifying the access point that outputs the received radio signal. Hereinafter, the identification information is referred to as the SSID.

Data necessary for information processing performed by electronic device 100 is temporarily or permanently stored in storage 220. For example, a program or a data referred to by the program is stored in storage 220. For example, storage 220 is configured by a volatile memory, a nonvolatile memory, a Hard Disc Drive (HDD), or a Solid State Drive (SSD). An operating system (OS) is stored in storage 220. The OS provides a user with a system that deals with a component included in electronic device 100 in a software manner. A program that performs various types of processing described below (hereinafter, simply referred to as “program” as appropriate) is stored in storage 220. Pieces of data, such as an SSID table, an operating environment setting table, and an operating environment definition file, which are to be described later, are also stored in storage 220.

Controller 210 controls whole operation of electronic device 100.

Controller 210 reads the OS or program from storage 220, and performs arithmetic processing based on the read program, thereby implementing various functions of electronic device 100. For example, controller 210 is configured by a CPU (Central Processing Unit), an MPU (Micro-Processing Unit), or an FPGA (Field-Programmable Gate Array).

Bus 230 is a signal path through which each component constituting electronic device 100 transmits and receives various signals to and from another component. Display 110, keyboard 130, touch pad 140, and operation button 150, which are illustrated in FIG. 1, are connected to bus 230 in addition to controller 210, storage 220, and radio communication unit 120.

2. Operation

2-1. Operation of Connection to Access Point

As described above, in electronic device 100, radio communication unit 120 can transmit and receive the wireless-LAN radio signal of the IEEE 802.11 standard. Upon receipt of a connection request signal from a slave unit such as electronic device 100, the access point of a wireless-LAN system transmits a transmission request signal for a connection password used to connect the slave unit to the access point. When electronic device 100, which is the slave unit, has the connection password of the access point, electronic device 100 transmits the connection password to the access point. The access point performs authentication based on the connection password transmitted from electronic device 100. When the connection password is correct, the access point permits electronic device 100 to be connected to the access point, and allows electronic device 100 to conduct radio communication through the access point.

2-2. Operating environment setting operation during starting of electronic device

2-2-1. Outline

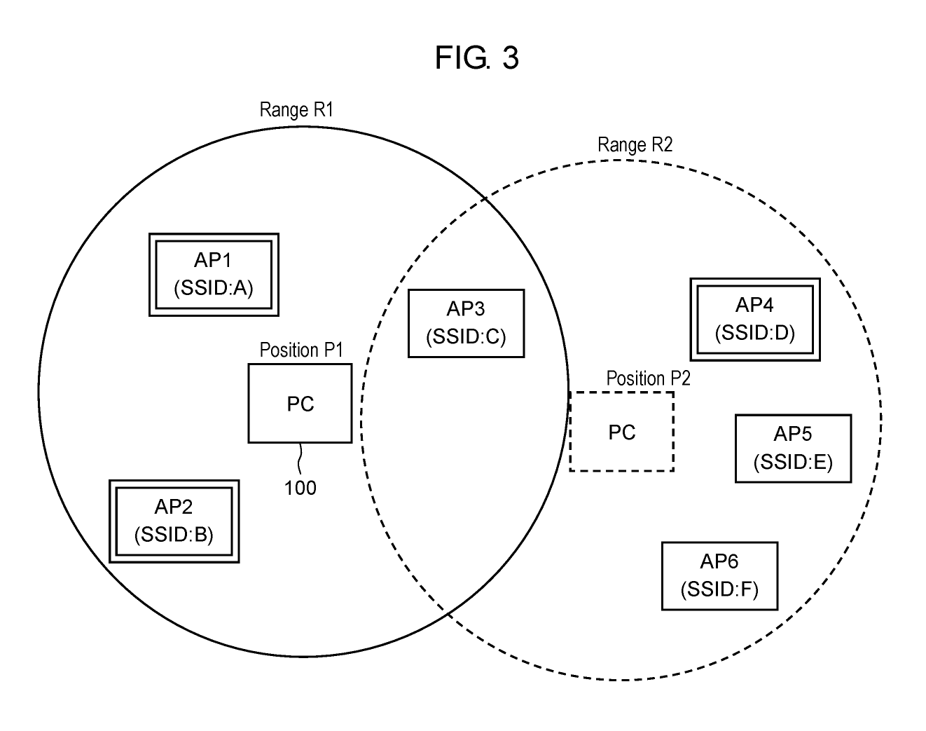

For example, electronic device 100 is used in a radio wave environment as illustrated in FIG. 3. FIG. 3 is a view illustrating an example of the radio wave environment of electronic device 100. In this example, in electronic device 100, user X and user Y are registered as a user. Position P1 is a position of a seat where user X exists usually in an office, and position P2 is a position of a seat where user Y exists usually in the office.

Six access points AP1 to AP6 exist in the example of FIG. 3. When electronic device 100 is located at position P1, electronic device 100 can receive the radio signal from three access points AP1 to AP3 existing within range R1 relatively close to position P1. However, electronic device 100 cannot receive the radio signal from three access points AP4 to AP6 existing relatively far away from position P1. When electronic device 100 cannot receive the radio signal from the access point, electronic device 100 cannot obtain the SSID of the access point.

In this example, electronic device 100 previously stores the connection password necessary for the connection to access points AP1, AP2, AP4 in storage 220. When a predetermined condition is satisfied, electronic device 100 can be connected to access points AP1, AP2, AP4 to conduct radio communication through the access point. That is, access points AP1, AP2, AP4 are the access points (indicated by a double frame in FIG. 3) to which electronic device 100 can be connected.

On the other hand, when electronic device 100 is located at position P2, electronic device 100 can receive the radio signal from four access points AP3 to AP6 existing within range R2 relatively close to position P2. However, electronic device 100 cannot receive the radio signal from two access points AP1, AP2 existing relatively far away from position P2. When electronic device 100 cannot receive the radio signal from the access point, electronic device 100 cannot obtain the SSID of the access point.

In the present exemplary embodiment, by focusing attention to the fact that the receivable radio signal (SSID) changes according to the position of electronic device 100, the following operation is performed to improve the security. Specifically, electronic device 100 performs operating environment setting of electronic device 100 based on the SSID, which is obtained from the radio signal received during the starting of electronic device 100 (predetermined timing), and authentication information, such as a user ID, which is input by the user when the OS authentication is performed during the starting of electronic device 100. For example, the operating environment setting includes setting of a usable function in all the functions of electronic device 100 and setting of a display item on a screen. As used herein, “during the starting of electronic device 100” refers to a period since a power button of electronic device 100 is pressed by the user, electronic device 100 performs initialization processing of the OS or application, and the log-in processing of the user into the OS is completed, until the user can start the application.

For example, at position P1 where user X performs regular work, there is a high possibility that electronic device 100 receives the SSID from access points AP1 to AP3. Therefore, during the starting of electronic device 100, all the functions of electronic device 100 can be performed, when the user ID input in the OS authentication is the user ID of user X while electronic device 100 receives the radio signal from access points AP1 to AP3. This enables user X to perform regular work using electronic device 100 at position P1 of the own seat.

On the other hand, even if the input authentication information is the user ID or password of user X, there is a possibility that electronic device 100 is moved to a position different from seat position P1 of user X when the radio signal is not received from access points AP1 to AP3 during the starting of electronic device 100. In such cases, electronic device 100 can perform only some functions in all the functions of electronic device 100. The position different from position P1 is a home of user X, for example. In this case, the functions of electronic device 100 are set (restricted) so that secret information about an office is inaccessible.

For example, at position P2 where user Y performs regular work, there is a high possibility that electronic device 100 receives the SSID from access points AP3 to AP6. Therefore, for example, all the functions of electronic device 100 can be performed, when electronic device 100 receives the radio signal from access points AP3 to AP6 during the starting of electronic device 100 and the input authentication information is the user ID or password of user Y. This enables user Y to perform regular work using electronic device 100 at position P2 of the own seat. The function usable at position P1 by user X may differ from the function usable at position P2 by user Y.

On the other hand, even if the authentication information, such as the user ID and the password, input during the OS authentication is the user ID or password of user Y, there is a possibility that electronic device 100 is moved to a position different from seat position P2 of user Y when the radio signal is not received from access points AP3 to AP6. In such cases, electronic device 100 can perform only some functions in all the functions of electronic device 100. The position different from position P2 may be a home of user Y. In this case, for example, the functions of electronic device 100 are set (restricted) so that secret information about an office is inaccessible. The function usable by user X may differ from the function usable by user Y.

Thus, in the present exemplary embodiment, the operating environment setting of movable electronic device 100 may be varied according to the position where electronic device 100 exists and the user ID of the user who uses electronic device 100. Therefore, in the mobile type electronic device, the degradation of the user-friendliness can be prevented while the security is ensured.

2-2-2. Specific Operating Environment Setting Operation

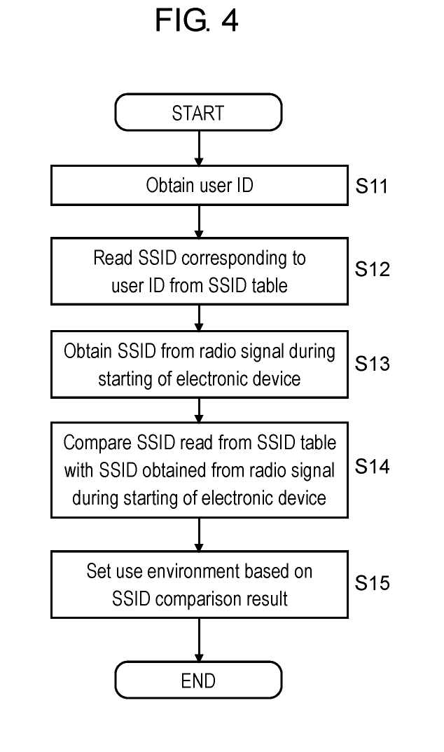

The operating environment setting operation during the starting of electronic device 100 will be described below with reference to a flowchart in FIG. 4. FIG. 4 is a flowchart illustrating operating environment setting processing during the starting of electronic device 100 according to the first exemplary embodiment. For example, the user operates the power switch of electronic device 100 to start the OS, a program for the operating environment setting is read and executed during the starting of the OS, thereby performing the operating environment setting processing. For example, the program is read before the OS performs pieces of processing such as display of a log-in window. The user inputs the user ID and the log-in password using keyboard 130, and the OS completes the user authentication processing. Then, the pieces of processing from step S11 are started.

When the OS completes the user authentication processing, controller 210 obtains the user ID input when logging in to the OS (step S11).

Controller 210 reads the SSID from the SSID table stored in storage 220 (step S12). Specifically, controller 210 refers to the SSID table stored in storage 220, and obtains the SSID corresponding to the user ID input in step S11. Note that the SSID is initially recorded in the SSID table at a predetermined time during initial operation after electronic device 100 is introduced. The predetermined time with respect to the recording of the SSID in the SSID table will be described later. The SSID table may properly be updated by a person who has certain use authorization and the like.

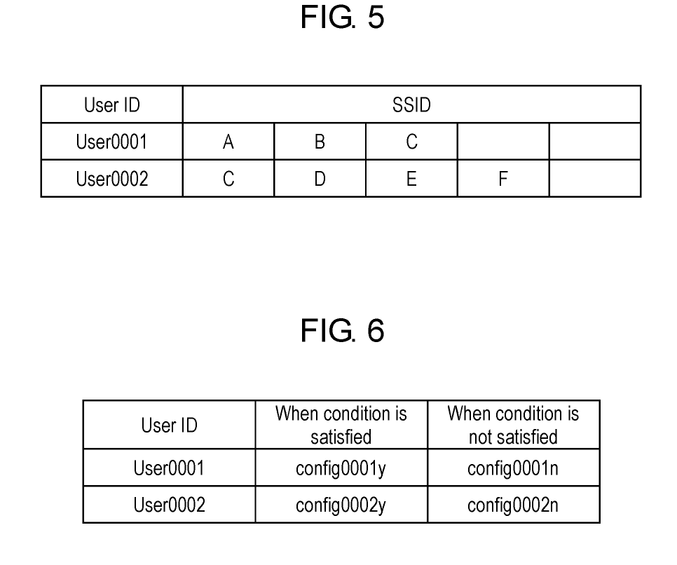

FIG. 5 is a view illustrating an example of the SSID table of electronic device 100 according to the first exemplary embodiment. In the SSID table, the SSID is managed while correlated to the user ID. For example, “A”, “B”, “C” are recorded as the SSID with respect to the user ID “User0001”, and “C”, “D”, “E”, “F” are recorded as the SSID with respect to the user ID “User0002”. The SSIDs are obtained by radio communication unit 120 at the predetermined time (details will be described later).

Controller 210 obtains the SSID from the radio signal that is currently received with radio communication unit 120 (step S13).

Controller 210 compares the SSID read from the SSID table with the

SSID of the access point that is obtained through radio communication unit 120 during the starting of electronic device 100 (step S14). A specific comparison method will be described later.

Controller 210 sets an operating environment of electronic device 100 based on a comparison result of the SSID (step S15). Specifically, controller 210 determines whether the comparison result satisfies a predetermined condition, and obtains a file name of an operating environment definition file corresponding to a combination of the user ID and the SSID from the operating environment setting table based on the user ID and the comparison result of the SSID. Controller 210 reads the operating environment definition file corresponding to the obtained file name, and sets the operating environment (operation) of electronic device 100 based on an operating environment parameter recorded in the operating environment definition file. In each operating environment definition file, the function usable by the user corresponding to the user ID, such as a usable application and connection propriety to a network, is recorded. Various types of setting information such as a file name of a desktop wallpaper during operation and a file name of an icon disposed on the desktop are also recorded in the operating environment definition file.

Shut-down of electronic device 100 is defined in the operating environment definition file that is used when the predetermined condition is not satisfied, and the electronic device may be shut down when the SSID obtained during the starting of electronic device 100 does not satisfy the predetermined condition. Alternatively, in the operating environment definition file that is used when the predetermined condition is not satisfied, and a request to input a new password (a password different from the password necessary for the OS authentication) is defined when the predetermined condition is not satisfied. In the case where the authentication is completed using the new password, the user can use electronic device 100 under the operating environment setting defined in the operating environment definition file. Alternatively, instead of the request to input the new password, a predetermined question may be asked for confirmation. If there is a proper response to the predetermined question, the operating environment setting defined in the operating environment definition file may enable the user to use electronic device 100.

FIG. 6 is a view illustrating an example of the operating environment setting table of electronic device 100 according to the first exemplary embodiment. The file name of the operating environment definition file that is used when the comparison result satisfies the predetermined condition and the file name of the operating environment definition file that is used when the comparison result does not satisfy the predetermined condition are recorded in the operating environment setting table while correlated with the plurality of user IDs. For example, for the user ID “User0001”, “config0001y” is recorded as the file name of the operating environment definition file that is used when the comparison result satisfies the predetermined condition, and “config0001n” is recorded as the file name of the operating environment definition file that is used when the comparison result does not satisfy the predetermined condition. For the user ID “User0002”, “config0002y” is recorded as the file name of the operating environment definition file that is used when the comparison result satisfies the predetermined condition, and “config0002n” is recorded as the file name of the operating environment definition file that is used when the comparison result does not satisfy the predetermined condition.

First to fifth examples of the predetermined condition in step S15 of FIG. 4 will be described below. Which one of the predetermined conditions is used may be set based on strictness of the security required for electronic device 100.

<First Example of Predetermined Condition>

The predetermined condition is that the SSIDs recorded in the SSID table are completely matched to the SSID obtained during the starting of electronic device 100.

<Second Example of Predetermined Condition>

The predetermined condition is that at least a predetermined number of SSIDs recorded in the SSID table are matched to the SSID obtained during the starting of electronic device 100.

<Third Example of Predetermined Condition>

The predetermined condition is that a ratio of match between the SSIDs recorded in the SSID table and the SSID obtained during the starting of electronic device 100 is greater than or equal to a predetermined value.

<Fourth Example of Predetermined Condition>

The predetermined condition is that the SSID obtained during the starting of electronic device 100 includes the SSID of the access point to which electronic device 100 is connectable while all the SSIDs, in which the connectable SSIDs and the unconnectable SSIDs are added, satisfy one of the first to third examples of the predetermined condition. The access point to which electronic device 100 is connectable is an access point whose authentication information necessary for the connection is owned by electronic device 100. On the other hand, the access point to which electronic device 100 is unconnectable is an access point whose authentication information necessary for the connection is not owned by electronic device 100.

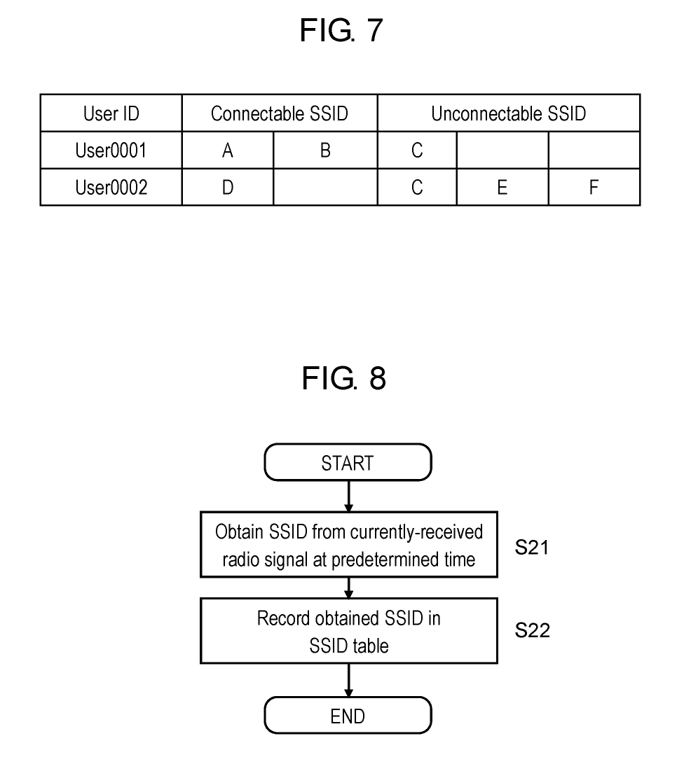

Specifically, an SSID table in FIG. 7 is used as the SSID table. FIG. 7 is a view illustrating another example of the SSID table of electronic device 100 according to the first exemplary embodiment. The SSIDs obtained at a predetermined time (to be described later) are recorded in the SSID table of FIG. 7 for each of a plurality of user IDs while classified into the connectable SSID and the unconnectable SSID. For example, for the user ID “User0001”, “A”, “B” are recorded as the connectable SSID, and “C” is recorded as the unconnectable SSID. For example, for the user ID “User0002”, “D” is recorded as the connectable SSID, and “C”, “E”, “F” are recorded as the unconnectable SSID.

<Fifth Example of Predetermined Condition>

The predetermined condition is that an SSID of a predetermined access point device is included in the SSID obtained during the starting of electronic device 100. For example, the predetermined access point device is an access point device owned by an authorized person having authority to use electronic device 100. For example, the access point device is a Wi-Fi router always owned by a certain user, a mobile phone having a tethering function, or a smartphone.

In this example, the SSID of the predetermined access point device is registered in the SSID table. In this example, unless the predetermined access point device always owned by a certain user exists near electronic device 100, the predetermined condition is not satisfied even if electronic device 100 is started. A user other than a certain user cannot use electronic device 100 under the same operating environment setting as a certain user having the predetermined access point device.

2-3. SSID Recording Processing During Operation of Electronic Device

FIG. 8 is a flowchart illustrating SSID recording processing during the operation of electronic device 100 according to the first exemplary embodiment. From the viewpoint of security, preferably, a person having the use authority to a certain extent records the SSID when electronic device 100 is introduced.

Controller 210 obtains the SSID through radio communication unit 120 at the predetermined time during the operation of electronic device 100 (step S21).

Controller 210 records the SSID obtained at the predetermined time in the SSID table while correlating the SSID with the user ID of the currently logged-in user (step S22).

First to fifth examples of the “predetermined time” will be described below.

<First Example of Predetermined Time>

The predetermined time is a whole period since the user logs in to electronic device 100 until the user logs out from electronic device 100. Therefore, all the SSIDs obtained by the user during the use of electronic device 100 are recorded. Even if the user moves in a wide range during the log-in, the user can use electronic device 100 under one operating environment setting.

<Second Example of Predetermined Time>

The predetermined time is predetermined date and time. For example, in the case where electronic device 100 is mainly used in the office, the predetermined time is 8:00 to 20:00 on Monday to Friday. Therefore, on the date and time other than the predetermined date and time, it is possible to make electronic device 100 unusable under the same operating environment setting as the predetermined date and time.

<Third Example of Predetermined Time>

The predetermined time is a predetermined time point. For example, the predetermined time is the time when the user issues an instruction to record the SSID through keyboard 130 or the like. Therefore, for example, when going on a business trip outside the office, the user can use electronic device 100 on the business trip. At a place where a wireless LAN environment does not exist, the authentication is performed by the SSID using the Wi-Fi router or the tethering function of the mobile phone, and electronic device 100 is made usable. In the case where the viewpoint of security is emphasized, preferably, a person having the use authority to a certain extent records the SSID of the Wi-Fi router and the like.

<Fourth Example of Predetermined Time>

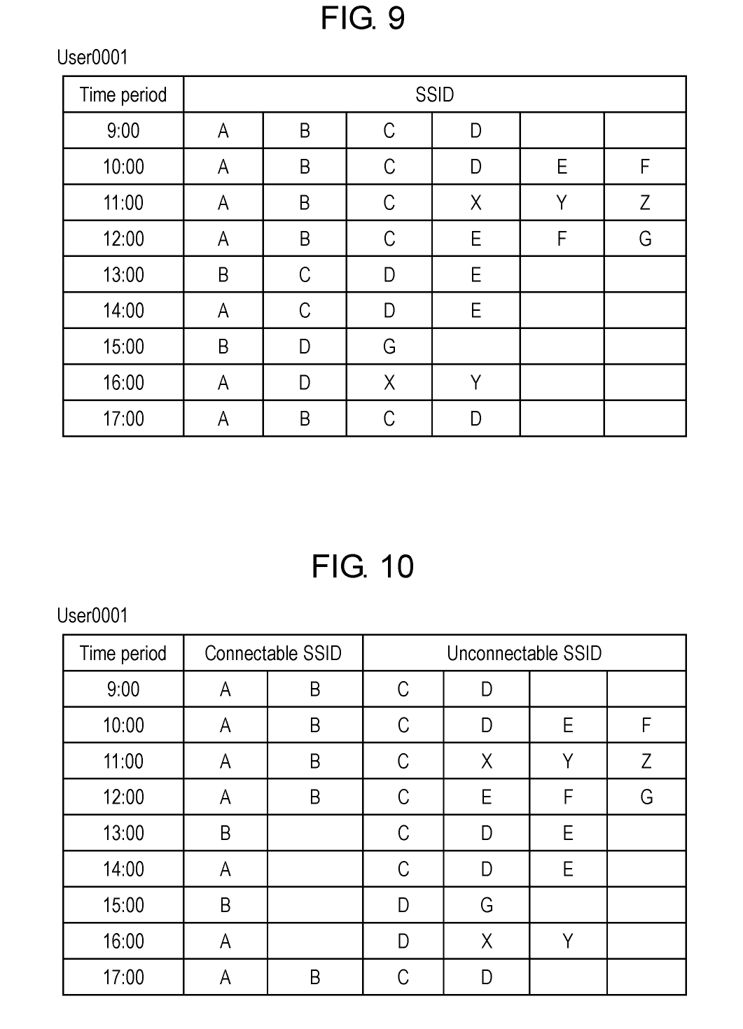

The SSID may be managed in each predetermined time. In the example of FIG. 9, the SSID is managed in each hour. Specifically, controller 210 manages the obtained SSID of the access point while correlating the SSID with the user ID and a time period including the obtained time.

Specifically, the SSID table in FIG. 9 is used as the SSID table. FIG. 9 is a view illustrating still another example of the SSID table of electronic device 100 according to the first exemplary embodiment. In this example, the SSID table is provided for each user ID. In this example, the SSID obtained in each time period is recorded while correlated with each time period. For example,

“A”, “B”, “C”, “D” are recorded as the SSID at a time period 9:00, and “A”, “B”, “C”, “D”, “E”, “F” are recorded as the SSID at a time period 10:00.

In this example, controller 210 compares the SSID obtained during the current starting of electronic device 100 with the SSID, which is recorded in the time period to which the time during the current starting of electronic device 100 belongs in the SSIDs managed by the SSID table, and determines whether the predetermined condition is satisfied based on the comparison result. One of the first to third examples of the predetermined condition may be used as a criterion.

With this configuration, the following effect is obtained. The operating state of the access point device near the use place of electronic device 100 changes even if the use place does not change. In such cases, when the obtained SSID is not classified into each predetermined time, sometimes the comparison result does not satisfy the predetermined condition in a certain time period while the comparison result satisfies the predetermined condition in another time period. However, when the obtained SSID is classified into each predetermined time, the SSID is read from the SSID table according to the time period during the starting of electronic device 100. Therefore, whether the predetermined condition is satisfied can properly be determined according to the time period during the starting of electronic device 100.

The SSID may be managed in each day of the week. In this case, controller 210 compares the SSID obtained during the current starting of electronic device 100 with the SSID, which is recorded in the field of the day of week corresponding to the day of week during the current starting of electronic device 100 in the SSIDs managed by the SSID table, and determines whether the predetermined condition is satisfied based on the comparison result. One of the first to third examples of the predetermined condition may be used as a criterion.

Alternatively, the SSID may be managed while correlated with the day of week and the time period. In this case, controller 210 compares the SSID obtained during the current starting of electronic device 100 to the SSID, which is recorded in a field of the day of week and time period corresponding to the day of week and time period during the current starting of electronic device 100 in the SSIDs recorded in the SSID table, and determines whether the predetermined condition is satisfied based on the comparison result. One of the first to third examples of the predetermined condition may be used as a criterion.

<Fifth Example of Predetermined Time>

As illustrated in FIG. 10, the SSID obtained in each time period, which is the SSID of the fourth example at the predetermined time, may further be managed while classified into the SSID of the connectable access point and the SSID of the unconnectable access point. In this case, the determination for the match of the SSIDs may be made in each time period by the fourth example of the predetermined condition.

3. Effects and the Like

As described above, electronic device 100 of the present exemplary embodiment includes radio communication unit 120 (obtainment unit) that obtains the SSID (the identification information and position-dependent information about the access point) that is the information dependent on the position of electronic device 100. Electronic device 100 also includes storage 220 in which the SSID table is stored, the SSID table managing the SSID obtained by radio communication unit 120 and authentication information used by the user to log in to electronic device 100 while correlating the SSID and the authentication information to each other, and controller 210 that performs the operating environment setting of electronic device 100.

Controller 210 compares the SSID obtained in predetermined timing by radio communication unit 120 with the SSID corresponding to the authentication information about the currently logged-in user in the SSIDs managed by the SSID table, and changes the operating environment setting of electronic device 100 according to the comparison result.

Therefore, the operating environment setting of electronic device 100 is automatically changed at the position different from the use place associated with the SSID (position-dependent information) correlated with the authentication information about the user. Accordingly, in the case where a person other than the authorized user takes out electronic device 100, because the SSID varies even if the person can log in to electronic device 100, electronic device 100 operates under the operating environment setting different from that of the authorized user. For example, when a function is greatly restricted as the operating environment setting, use of data of the authorized user can be made difficult for the person other than the authorized user. Accordingly, the security is improved. When the authorized user moves with electronic device 100, electronic device 100 can be operated under the operating environment setting corresponding to the movement position, and the user-friendliness is ensured. Therefore, both the security and the user-friendliness can be achieved.

In the present exemplary embodiment, the operating environment setting includes setting of a function usable by the currently logged-in user.

Therefore, the function usable by the currently logged-in user can automatically be set according to the authentication information about the user who uses electronic device 100 and the use place of electronic device 100.

In the present exemplary embodiment, electronic device 100 further includes display 110 that performs display based on an image signal output from controller 210, and controller 210 includes setting of an element displayed on display 110 as the operating environment setting.

Therefore, the element displayed on display 110 can automatically be set according to the authentication information about the user who uses electronic device 100 and the use place of electronic device 100.

In the present exemplary embodiment, the SSID table (table) manages all the SSIDs that are pieces of position-dependent information, which are obtained after the user logs in to the electronic device until the user logs out from the electronic device.

Therefore, even if the user moves in a wide range during the log-in, the user can use electronic device 100 under one operating environment setting.

In the present exemplary embodiment, the SSID table manages the SSID obtained on the predetermined day.

Therefore, on the day other than the predetermined day, it is possible to make electronic device 100 unusable under the same operating environment setting as the predetermined day.

In the present exemplary embodiment, the SSID table further manages the obtained SSID in each predetermined time period.

Therefore, on the date and time other than the predetermined time period on the predetermined day, it is possible to make electronic device 100 unusable under the same operating environment setting as the predetermined day.

In the present exemplary embodiment, the SSID table manages the SSID obtained at the predetermined time point.

Therefore, for example, when going on a business trip outside the office, the user can use electronic device 100 on the business trip.

In the present exemplary embodiment, in the case where the SSID table manages the plurality of SSIDs for each user, controller 210 determines whether all the plurality of SSIDs obtained in the predetermined timing are matched to the SSIDs corresponding to the authentication information about the currently logged-in user in the SSIDs managed by the SSID table, and changes the operating environment setting of electronic device 100 according to the determination result.

Therefore, for example, it is possible to make electronic device 100 unusable under the predetermined operating environment setting except when all the SSIDs obtained in the predetermined timing are matched to the SSIDs corresponding to the authentication information about the currently logged-in user in the SSIDs managed by the SSID table.

In the present exemplary embodiment, in the case where the SSID table manages the plurality of SSIDs for each user, controller 210 operates as follows. Controller 210 determines whether a ratio of match between the plurality of SSIDs obtained in the predetermined timing and the SSID corresponding to the authentication information about the currently logged-in user in the SSIDs managed by the SSID table is greater than or equal to a predetermined value, and changes the operating environment setting of electronic device 100 according to the determination result.

Therefore, for example, it is possible to make electronic device 100 unusable under the predetermined operating environment setting except when the ratio of match between the SSIDs is greater than or equal to the predetermined value.

In the present exemplary embodiment, in the case where the SSID table manages the plurality of SSIDs for each user, controller 210 operates as follows. Controller 210 determines whether at least a predetermined number of the plurality of SSIDs obtained in the predetermined timing are matched to the SSID corresponding to the authentication information about the currently logged-in user in the SSIDs managed by the SSID table, and changes the operating environment setting of electronic device 100 according to the determination result.

Therefore, for example, it is possible to make electronic device 100 unusable under the predetermined operating environment setting except when at least the predetermined number of SSIDs obtained in the predetermined timing are matched to the SSID corresponding to the authentication information about the currently logged-in user in the SSIDs managed by the SSID table.

In the present exemplary embodiment, in addition to the above determination, controller 210 further determines whether the plurality of SSIDs obtained in the predetermined timing include the SSID of the connectable access point, and changes the operating environment setting of electronic device 100 according to the determination results.

Therefore, for example, it is possible to make electronic device 100 unusable under the predetermined operating environment setting except when the plurality of SSIDs obtained in the predetermined timing include the SSID of the connectable access point.

In the present exemplary embodiment, the position-dependent information is the SSID (identification information) of the access point having a predetermined radio communication system.

Therefore, the operating environment setting of electronic device 100 can be performed based on the SSID of the access point having a predetermined radio communication system.

### Second Exemplary Embodiment

In the first exemplary embodiment, the SSID obtained during the starting of electronic device 100 and the SSID stored in storage 220 are compared with each other during the starting of electronic device 100, and one of the two settings is adopted based on whether the comparison result satisfies the predetermined condition. However, the present disclosure is not limited to the first exemplary embodiment. For example, in the case where electronic device 100 is disposed at a position (place) where the access points of the SSIDs “A”, “B”, “C”, “D”, “E” can hardly be obtained at the same time, the operating environment definition file corresponding to each SSID is provided, and the operating environment setting may be changed according to the obtained SSID.

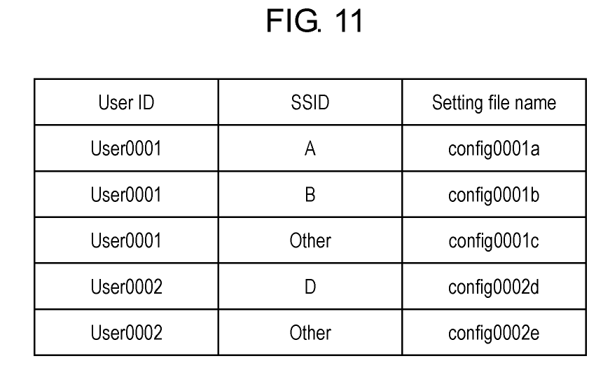

FIG. 11 is a view illustrating an example of an SSID and operating environment setting table of an electronic device according to a second exemplary embodiment. For example, for the user ID “User0001”, the operating environment setting is performed using an operating environment definition file “config0001a” in the case where the SSID “A” in the SSIDs recorded in the SSID table is obtained. In the case where the SSID “B” is obtained, the operating environment setting is performed using an operating environment definition file “config0001b”. In the case where other SSID is obtained, or in the case where any SSIDs are not obtained, the operating environment setting may be performed using an operating environment definition file “config0001c”.

For the user ID “User0002”, the operating environment setting is performed using an operating environment definition file “config0002d” in the case where the SSID “D” in the SSIDs recorded in the SSID table is obtained. In the case where other SSID is obtained, or in the case where any SSIDs are not obtained, the operating environment setting may be performed using an operating environment definition file “config0002e”.

In the present exemplary embodiment, according to various places (movement destinations) of one user, electronic device 100 can be operated under the operating environment setting suitable for the place. For example, in the case where an application to be used is already fixed at each place, the operating environment setting under which the application is used can automatically be performed at each place. Therefore, the user-friendliness is improved.

### Other Exemplary Embodiments

The first and second exemplary embodiments are described above as examples of the technique in the present disclosure. However, the technique of the present disclosure is not limited to the first and second exemplary embodiments, and is applicable to another exemplary embodiment in which a change, a replacement, an addition, or an omission is appropriately made. A new exemplary embodiment can also be made by a combination of the components of the first exemplary embodiment.

Accordingly, another exemplary embodiment will be described below. In the above exemplary embodiments, the position-dependent information is the wireless-LAN SSID. However, any piece of position-dependent information can be used as the position-dependent information of the present disclosure as long as the electronic device can obtain the position-dependent information. For example, the position-dependent information of the present disclosure may be identification information about a wireless device pursuant to a Bluetooth (registered trademark) standard. In this case, the control can be performed similarly to the use of the wireless-LAN SSID. The position-dependent information may be positioning information obtained by a GPS (Global Positioning System) or an AGPS (Assisted Global Positioning System). In this case, controller 210 compares the positioning information (such as time information) obtained in the predetermined timing by the GPS or AGPS with the positioning information corresponding to the authentication information about the currently logged-in user in pieces of positioning information managed by the table, and changes the operating environment setting of electronic device 100 according to the comparison result. The position-dependent information may be channel information about terrestrial TV broadcasting. In this case, controller 210 compares the channel information obtained in the predetermined timing with the channel information corresponding to the channel information about the user who currently logs in electronic device 100 in pieces of channel information managed by the table, and changes the operating environment setting of electronic device 100 according to a comparison result. A determination method similar to the determination method in which the SSID is used may be adopted in these cases.

In the above exemplary embodiments, the table is illustrated in the tabular format by way of example. In the present disclosure, the table may be illustrated in any recording format including a text-data format such as CSV format as long as the user ID and the position-dependent information are recorded while correlated with each other. The same holds true for the operating environment setting table.

The electronic device of the present disclosure can be used in electronic devices such as a desktop computer, a tablet computer, and a smartphone.

The exemplary embodiments are described above as examples of the technique in the present disclosure. The accompanying drawings and detailed description are provided for this purpose.

Accordingly, the components described in the appended drawings and the detailed description include, not only essential components for solving the problem, but also nonessential components for solving the problem in order to exemplify the above described technique. Therefore, it should not be immediately construed that these nonessential components are essential even if the components are described in the appended drawings and the detailed description.

Because the above exemplary embodiments are for exemplifying the technique in the present disclosure, various modifications, replacements, additions, and omissions can be made within the scope of the appended claims or of their equivalents.

As described above, the present disclosure can widely be applied to electronic devices such as a desktop computer, a tablet computer, and a smartphone.

What is claimed is:

1. An electronic device comprising:
an obtainment unit that obtains position-dependent information, the position-dependent information being information depending on a position of the electronic device;
a storage in which a table is stored, the table managing the position-dependent information obtained by the obtainment unit and authentication information used by a user to log in to the electronic device while correlating the position-dependent information and the authentication information to each other; and
a controller that performs operating environment setting of the electronic device,
wherein the controller
compares the position-dependent information obtained in predetermined timing by the obtainment unit with the position-dependent information corresponding to the authentication information about the user who is currently logged in to the electronic device in pieces of position-dependent information managed by the table, and
changes the operating environment setting of the electronic device according to a comparison result.

2. The electronic device according to claim 1, wherein the operating environment setting performed by the controller includes setting of a function usable by the user who is currently logged in to the electronic device.

3. The electronic device according to claim 1, further comprising a display that performs display based on a signal output from the controller,
wherein the operating environment setting performed by the controller includes setting of an element displayed on the display.

4. The electronic device according to claim 1, wherein the table manages all the pieces of position-dependent information, which are obtained since the user logs in to the electronic device until the user logs out from the electronic device.

5. The electronic device according to claim 1, wherein the table manages the position-dependent information obtained on a predetermined day.

6. The electronic device according to claim 4, wherein the table further manages the obtained position-dependent information in each predetermined time period.

7. The electronic device according to claim 1, wherein the table manages the position-dependent information obtained at a predetermined time point.

8. The electronic device according to claim 1, wherein
when the table manages a plurality of the pieces of position-dependent information for each user,
the controller
determines whether all the plurality of pieces of position-dependent information obtained in the predetermined timing are matched to the position-dependent information corresponding to the authentication information about the user who is currently logged in to the electronic device in the pieces of position-dependent information managed by the table, and
changes the operating environment setting of the electronic device according to a determination result.

9. The electronic device according to claim 1, wherein
when the table manages a plurality of the pieces of position-dependent information for each user,
the controller determines whether a ratio of match between the plurality of pieces of position-dependent information obtained in the predetermined timing and the authentication information about the user who is currently logged in to the electronic device in the pieces of position-dependent information managed by the table is greater than or equal to a predetermined value, and changes the operating environment setting of the electronic device according to a determination result.

10. The electronic device according to claim 1, wherein
when the table manages a plurality of the pieces of position-dependent information for each user,
the controller determines whether at least a predetermined number of the plurality of pieces of position-dependent information obtained in the predetermined timing are matched to the position-dependent information corresponding to the authentication information about the user who is currently logged in to the electronic device in the pieces of position-dependent information managed by the table, and changes the operating environment setting of the electronic device according to a determination result.

11. The electronic device according to claim 8, wherein, in addition to the determination result, the controller further determines whether the plurality of pieces of position-dependent information obtained in the predetermined timing include the position-dependent information about a connectable access point, and changes the operating environment setting of the electronic device according to determination results.

12. The electronic device according to claim 1, wherein the position-dependent information is identification information about an access point having a predetermined radio communication system.
